(19) United States
(12) Patent Application Publication
(10) Pub. No.: US 2012/0194398 A1
(43) Pub. Date: Aug. 2, 2012

(54) RADIO FREQUENCY TRANSMITTING DEVICE

(75) Inventors: Jean-Pierre Brasile, Colombes (FR); Friedman Tchoffo Talom, Colombes (FR); Patrick Sirot, Colombes (FR)

(73) Assignee: THALES, Neuilly Sur Seine (FR)

(21) Appl. No.: 13/337,794

(22) Filed: Dec. 27, 2011

(30) Foreign Application Priority Data
Dec. 27, 2010 (FR) 1005126

(51) Int. Cl. H01Q 3/00

(52) U.S. Cl. 343/763

(57) ABSTRACT

The present invention relates to a transmitting device, comprising an electromagnetic radiation source, an array-type antenna having an axis of transmission (T-T) and a guiding conduit for guiding the electromagnetic radiation from the source to the antenna. The antenna is able to rotate relative to the radiation source around an axis (X-X), the axis (X-X) being angularly offset from the axis of transmission (T-T) and the guiding conduit comprises a first waveguide extending along the axis of rotation (X-X) of the antenna and rigidly connected to the antenna.

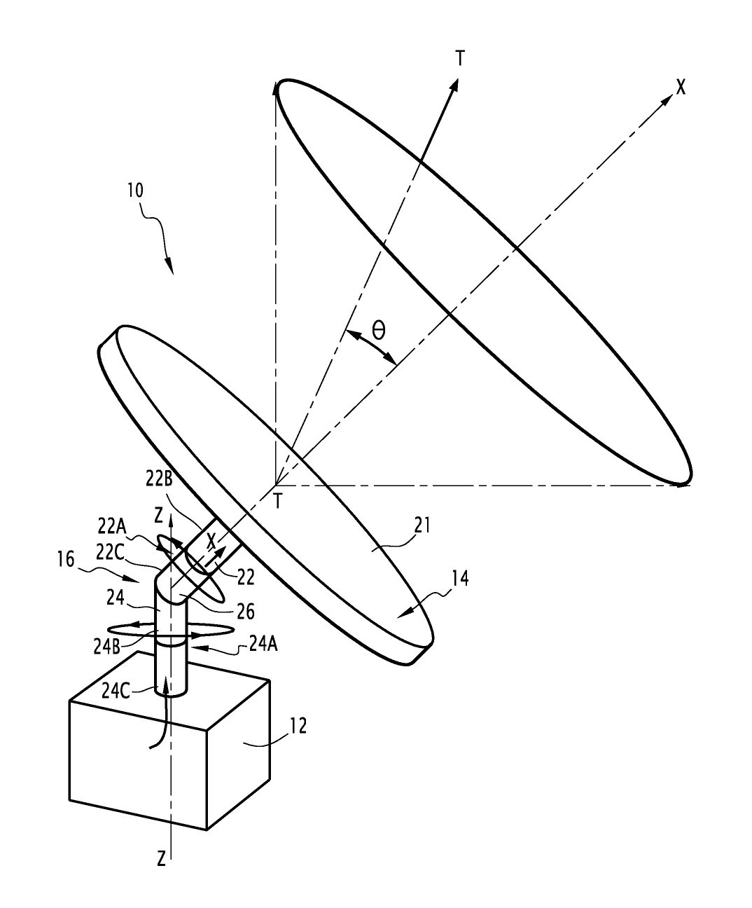

### BACKGROUND

The present invention relates to a radiofrequency transmitting device, of the transmission type comprising:

an electromagnetic radiation source;

an antenna of the array type having a transmission axis; and

a conduit for guiding the electromagnetic radiation from the source to the antenna.

Very high-power radiofrequency transmitting devices are known that comprise an antenna powered by an electromagnetic radiation source, for example made up of a high-powered magnetron.

The antenna is generally rigidly connected to the electromagnetic radiation source, which in turn is connected to its high-voltage power supply. It is therefore not possible to modify the transmission direction of the antenna without rotating the entire device.

In order to change the transmission direction of an antenna of the transmitting device, it is also known to make the antenna movable relative to the radiation source using a mobile and motorized support thereby making it necessary to have a guide conduit or angularly deformable waveguide to convey the electromagnetic flow from the source to the antenna. The deformation of the waveguide requires the use of complex mechanisms inasmuch as the flow must be guided in a vacuum. The articulations ensuring the deformation of the waveguide are often at the origin of breakdown phenomena and are therefore not adapted to very high powers or very significant travel.

Document U.S. Pat No. 4,862,185 describes an aiming system for which the primary radiated beam is capable of describing a cone of revolution around an axis of rotation. However, the proposed system comprising a transmitting antenna incorporating a reflector is not very compact and remains poorly adapted to high powers.

This problem was partially resolved in document U.S. Pat. No. 6,259,415 in the case of an array antenna using a fixed misalignment of the radiated beam relative to the axis of the antenna and the vertical rotary joint allowing the beam to describe a cone of revolution around the vertical axis. However, the proposed system comprises a mechanical device allowing mechanical travel of the antenna of ±25°, requiring a flexible coaxial connection to power the array antenna. Such a system is not adapted to high powers due to the breakdown limitations of such a connection.

The invention aims to propose a radiofrequency transmitting device making it possible to be used in an arrangement where the direction of the field radiated by the antenna is angularly mobile, while reducing the risks of breakdown.

To that end, the invention relates to a radiofrequency transmitting device of the aforementioned type, characterized in that the antenna is able to rotate relative to the radiation source around an axis, said axis being angularly offset from the transmission axis, and in that the guiding conduit comprises a first waveguide extending along the axis of rotation of the antenna and rigidly connected to the antenna.

According to specific embodiments, the radiofrequency transmitting device comprises one or more of the following features, considered alone or in combination:

the antenna rotates around an auxiliary axis angularly offset from the axis of rotation of the antenna;

the guiding conduit comprises a second waveguide extending along the auxiliary axis connected to the electromagnetic radiation source and the first waveguide;

the guiding conduit comprises a fixed angular opening bend connecting the first waveguide and the second waveguide;

the axis of rotation of the antenna forms an axis of revolution of the antenna;

the axis of rotation of the antenna and the auxiliary axis are cocurrent;

the device comprises a rotary joint connecting two consecutive coaxial sections of the first waveguide along the axis of rotation of the antenna;

the guiding conduit is adapted so that the electromagnetic radiation propagates from the source to the antenna according to a magnetic transverse mode TM₀₁; and

the device comprises a mode converter at the outlet of the source or the inlet of the antenna such that the electromagnetic radiation propagates according to the magnetic transverse mode TM₀₁ from the source to the antenna.

The invention will be better understood upon reading the following description, provided solely as an example and done in reference to the single appended figure, which is a perspective view of a radiofrequency wave transmitting device according to the invention.

The transmitting device 10 illustrated in the figure constitutes a microwave weapon capable of transmitting, in a particular direction T-T, an electromagnetic field intended to disrupt or destroy any device comprising electronics.

This device 10 comprises an electromagnetic radiation source 12 in the radiofrequency field made up of a high-powered tube and a transmitting antenna 14 connected to the source 12 by a waveguide 16.

The radiation source is high-powered, of several hundred megawatts, for example a magnetron, a MILO (Magnetically Insulated Line Oscillator), a carcinotron, or a relativistic klystron.

The transmitting antenna 14 comprises a planar transmission surface 21, on which a set of antenna elements is distributed capable of creating a coherent field in direction T-T by adding elementary fields, in phase in the considered direction, of the various antenna elements.

In the considered example, the transmitting antenna 14 is of revolution and has an axis of revolution X-X constituting a normal at the transmission surface 21. For example, the antenna is an antenna of the radial transmission line array, slot array, or reflect array type.

Furthermore, the transmitting antenna 14 is capable of transmitting along the direction T-T angularly offset by a fixed angle θ relative to the axis of revolution X-X of the antenna 14. Preferably, the angle θ between the axis of revolution X-X and the axis of transmission T-T of the antenna 14 is substantially equal to 45°.

Each antenna element is made up of a radiation source that is fixed relative to the transmission surface 21. Depending on the type of array antenna used, these sources are helices or slots. The position and the geometry of the radiation sources are calculated in a known manner to obtain the desired law of illumination and misalignment angle.

For example, the misalignment of the antenna is done according to document U.S. Pat. No. 6,259,415.

One can thus see that with such an arrangement, a coherent wave is produced by the addition of the elementary electromagnetic waves produced by each antenna element. The coherent wave propagates in direction T-T, forming a predefined angle θ relative to the normal of the transmission surface 21. According to the invention, the guiding conduit 16 comprises first 22 and second 24 waveguides connected by a fixed angular opening bend 26. The first and second waveguides 22, 24 are each rectilinear and are adapted to propagate the electromagnetic radiation from the source 12 to the antenna 14.

The first waveguide 22 is along the axis of revolution X-X of the antenna to which it is rigidly connected. Furthermore, the first waveguide is capable of rotating globally around the axis of revolution X-X while being driven by a first motor (not shown).

The propagation mode in the guide is magnetic transverse of type TM₀₁. Such a mode is the natural mode produced by the power tubes such as the MILO or the carcinotron. In the case where the output model of the considered tube is of another kind, the antenna 14 comprises, opposite the second waveguide 22, a metal cone capable of modifying the propagation mode of the electromagnetic flow, so as to obtain a magnetic transverse mode of type TM₀₁. The mode TM₀₁ in fact has the advantage of null axial electric and magnetic fields on the walls, which makes it possible to use a rotary joint without risk of breakdown, even at high powers.

Furthermore, the second waveguide 24 is connected to the electromagnetic radiation source. The second waveguide 24 extends along another axis Z-Z and is capable of rotating globally around said axis Z-Z while being driven by a second motor (not shown). The axis of the antenna X-X and the other axis Z-Z are cocurrent. In the considered example, the axis Z-Z is vertical.

The transmission device comprises two rotating rotary joints placed on the first and second waveguides. A first rotary joint 22A is positioned along the axis X-X, between two coaxial consecutive sections 22B, 22C of the first waveguide.

Likewise, the second rotary joint 24A is positioned along the axis Z-Z, between two consecutive sections 24B, 24C of the second waveguide.

Each rotary joint is formed by two consecutive coaxial sections connected by a ball bearing.

It will thus be understood that the antenna 14 is capable of rotating globally both around its axis of revolution X-X and around the other axis Z-Z.

The radiofrequency transmitting device according to the invention is also provided without other articulations forming degrees of angular freedom between the source 12 and the antenna 14, thereby reducing breakdown risks.

During operation, in such a transmitting device, the electromagnetic flow is generated by the electromagnetic radiation source. It propagates to the antenna 14 because of the guiding conduit 16 first along the axis Z-Z in the second waveguide 24, then along the axis of revolution of the antenna X-X in the first waveguide 22. The electromagnetic wave is then transmitted in the transmission direction T-T of the antenna angularly offset by an angle θ from the axis of revolution X-X of the antenna. In the case where the antenna 14 is powered in a mode other than mode TM₀₁, the mode converter modifies the propagation mode of the electromagnetic flow transmitted by the supply source of the antenna so as to obtain mode TM₀₁.

The first waveguide 22 globally rotates around the axis of revolution X-X through the actuation of the first motor.

It will be understood that the transmission direction T-T of the electromagnetic wave describes a cone whereof the generatrix forms an angle θ with the axis of revolution X-X of the antenna through the rotation of the first waveguide.

Furthermore, the second waveguide 24 globally rotates around the other axis Z-Z through the actuation of the second motor, thereby rotating the assembly formed by the first waveguide and the antenna.

It will be understood that such an arrangement makes it possible to transmit electromagnetic wave over 360° in a simple and high-performing manner.

Furthermore, the motion space of the antenna, which is generally large so as to have a large gain, is thus greatly limited, which is a major advantage for airborne systems equipped with such a transmitting device.

1-9. (canceled)

10. A transmitting device comprising:
an electromagnetic radiation source;
an array antenna having a transmission axis (T-T); and
a conduit for guiding the electromagnetic radiation from the source to the antenna,
the antenna is rotatable relative to the radiation source around an axis (X-X), the axis (X-X) being angularly offset from the transmission axis (T-T), and in that the guiding conduit comprises a first waveguide extending along the axis of rotation (X-X) of the antenna and rigidly connected to the antenna.

11. The transmitting device according to claim 10, the antenna rotates around an auxiliary axis (Z-Z) angularly offset from the axis of rotation (X-X) of the antenna.

12. The transmitting device according to claim 11, the guiding conduit comprises a second waveguide extending along the auxiliary axis (Z-Z) connected to the electromagnetic radiation source and the first waveguide.

13. The transmitting device according to claim 12, the guiding conduit comprises a fixed angular opening bend connecting the first waveguide and the second waveguide.

14. The transmitting device according to claim 10, the axis of rotation (X-X) of the antenna forms an axis of revolution of the antenna.

15. The transmitting device according to claim 11, the axis of rotation (X-X) of the antenna and the auxiliary axis (Z-Z) are concurrent.

16. The transmitting device according to claim 10, comprising a rotary joint connecting two consecutive coaxial sections of the first waveguide along the axis of rotation of the antenna.

17. The transmitting device according to claim 10, the guiding conduit is adapted so that the electromagnetic radiation propagates from the source to the antenna according to a magnetic transverse mode TM₀₁.

18. The transmitting device according to claim 17, comprising a mode converter at the outlet of the source or the inlet of the antenna such that the electromagnetic radiation propagates according to the magnetic transverse mode TM₀₁ from the source to the antenna.
